(19) United States
(12) Patent Application Publication
(10) Pub. No.: US 2019/0130481 A1
(43) Pub. Date: May 2, 2019

(54) Entity Segmentation for Analysis of Sensitivities to Potential Disruptions

(71) Applicant: FAIR ISAAC CORPORATION, Roseville, MN (US)

(72) Inventors: Gerald Fahner, Austin, TX (US); Brad Vancho, San Francisco, CA (US)

(21) Appl. No.: 15/801,265

(22) Filed: Nov. 1, 2017

(51) Int. Cl. G06Q 40/02; G06Q 10/04; G06F 7/50; G06F 17/30

(52) U.S. Cl. CPC G06Q 40/025; G06F 17/30985; G06F 7/50; G06Q 10/04

(57) ABSTRACT

In one aspect, a computer implemented method for segmenting a population based on sensitivities to potential disruptions is provided. The method includes receiving one or more attributes associated with a first entity. The method further includes calculating a sensitivity index for the first entity based on the one or more attributes. The method further includes calculating a second risk score for the first entity based on the sensitivity index and the first risk score of the entity. The method further includes outputting the second risk score to a user interface.

### TECHNICAL FIELD

The subject matter described herein relates to analysis of potential disruptions to a population, and more particularly to an entity segmentation and risk calculating systems and methods.

### BACKGROUND

Risk scoring is widely used by banks and other financial institutions for assessing, and reporting, a measure of the creditworthiness of individuals. Often, risk scores are generated for an individual for a particular transaction, such as obtaining a mortgage or other loan, or opening up a new credit line such as applying for a credit card. To generate a risk score, a risk management reporting agency, such as Experian, and typically at the request of a bank or financial institution, applies a modeling algorithm to the credit data associated with an individual.

Often, the individual is pre-sorted into one of a number of segments or scorecards within the overall modeling algorithm (“risk scoring system”). Each scorecard in the system has its own a unique set of characteristics or attributes to be calculated from an individual's risk report data. Based on what is typically a highly proprietary algorithm and weighting scheme, a risk scoring system will generate a score within a range of scores. Where the individual's score lands within the range of scores is a primary indication of that individual's creditworthiness. For instance, a score at a higher level of the range indicates that the individual may be a very low default risk and is likely to be extended credit by the bank or financial institution. Conversely, a score at a lower level of the range indicates that the individual may be a very high default risk, and is likely to be denied credit by the bank or financial institution. Risk scores have application in other areas as well, such as being a factor to determine the interest rate to charge for the loan or in determining a credit line adjustment.

Most of the effective and reliable risk scoring systems, such as the FICO® Scores produced by Fair Isaac Corporation of San Jose, Calif., focus their scoring on a comprehensive set of categories of information from the risk report, depending on the objective of the risk scoring system. For example, the FICO® Score is driven by a number of categories including, without limitation or particular weighting, payment history, amount of debt, length of credit history, type of new credit requested, and credit mix. A risk scoring algorithm may calculate characteristics from each of these categories, assign component score weights based on the characteristic values, and then produce an aggregate score.

When outputting a risk score, a risk bureau will usually also output up to five risk score factors indicating the top reasons why that score was not higher. For example, a report can include a risk score, as well as a list of factors that have weighed adversely on that score, such as the number of late payments, the ratio of balance to available credit, and/or a duration over which certain credit accounts have been held by the individual. Such factors may be helpful to the individual for understanding what might be affecting their risk score.

Conventional techniques do not take into account how certain financial and economic disruptions may affect a consumer's future payment performance and their future risk score. That is, given a consumer's history, conventional techniques do not take into account whether a risk score may move in a positive direction or negative direction.

Accordingly, what is needed is a solution that provides more accurate risk score predictions in response to future conditions that could affect a consumer's future payment performance or future risk score. Further, there is a need to segment a seemingly homogenous population into different groups in order to more accurately reflect their response to a future condition.

### SUMMARY

This document presents systems, methods, and techniques to analyze an entity's sensitivity index value and calculate a risk score based on the sensitivity index value, the sensitivity index value can indicate the entity's predicted response to a future condition/event.

In one aspect, a computer implemented method is provided. The method includes receiving, at a computer processor, one or more attributes associated with a first entity. The method further includes calculating, by the computer processor, a sensitivity index for the first entity based on the one or more attributes. The calculating the sensitivity index includes creating a matched sample of entities, the entities sharing at least one attribute value of the one or more attributes, the matched sample of entities comprising a first sub-population of the entities experiencing a first condition and a second sub-population of the entities experiencing a second condition, the first sub-population different from the second sub-population. Calculating the sensitivity index further includes calculating, for each entity of the matched sample of entities, a sensitivity value associated with the entity, the calculating comprising subtracting an expected performance under the first condition with an expected performance under the second condition. Calculating the sensitivity index further includes segmenting, by the computer processor, any sample of entities into two or more segments based on the sensitivity value of each entity, the sensitivity index comprising one of the two or more segments. The method further includes calculating, by the computer processor, a second risk score for the first entity based on the sensitivity index and the first risk score of the entity. The method further includes outputting, by the computer processor, the second risk score to a user interface.

In another aspect, a non-transitory computer program product storing instructions that, when executed by at least one programmable processor, cause at least one programmable processor to perform operations is provided. The operations include receiving, at a computer processor, one or more attributes associated with a first entity. The operations further include calculating, by the computer processor, a sensitivity index for the first entity based on the one or more attributes. Calculating the sensitivity index includes creating a matched sample of entities, the entities sharing at least one attribute value of the one or more attributes, the matched sample of entities comprising a first sub-population of the entities experiencing a first condition and a second sub-population of the entities experiencing a second condition, the first sub-population different from the second sub-population. Calculating the sensitivity index further includes calculating, for each entity of the matched sample of entities, a sensitivity value associated with the entity, the calculating comprising subtracting an expected performance under the first condition with an expected performance under the second condition. Calculating the sensitivity index further includes segmenting, by the computer processor, any sample of entities into two or more segments based on the sensitivity value of each entity, the sensitivity index comprising one of the two or more segments. The operations further include calculating, by the computer processor, a second risk score for the first entity based on the sensitivity index and the first risk score of the entity. The operations further include outputting, by the computer processor, the second risk score to a user interface.

In another aspect a system is provided. The system includes at least one programmable processor. The system further includes a machine-readable medium storing instructions that, when executed by the at least one processor, cause the at least one programmable processor to perform operations. The operations include receiving, at a computer processor, one or more attributes associated with a first entity. The operations further include calculating, by the computer processor, a sensitivity index for the first entity based on the one or more attributes. Calculating the sensitivity index includes creating a matched sample of entities, the entities sharing at least one attribute value of the one or more attributes, the matched sample of entities comprising a first sub-population of the entities experiencing a first condition and a second sub-population of the entities experiencing a second condition, the first sub-population different from the second sub-population. Calculating the sensitivity index further includes calculating, for each entity of the matched sample of entities, a sensitivity value associated with the entity, the calculating comprising subtracting an expected performance under the first condition with an expected performance under the second condition. Calculating the sensitivity index further includes segmenting, by the computer processor, any sample of entities into two or more segments based on the sensitivity value of each entity, the sensitivity index comprising one of the two or more segments. The operations further include calculating, by the computer processor, a second risk score for the first entity based on the sensitivity index and the first risk score of the entity. The operations further include outputting, by the computer processor, the second risk score to a user interface.

In some variations one or more of the following can optionally be included. Calculating the sensitivity index further includes determining a number of matched entities of a population that share similar attribute values of the at least on attribute at a start time but subsequently experience two different conditions, the number of entities satisfying a threshold, the matched sample of entities comprising the number of entities. Determining a number of matched entities of a population that share similar attribute values is based on a propensity score. Calculating the sensitivity index further includes regressing the matched entities' credit performance values based on the matched entities' attributes at the scoring date and based on the conditions subsequently experienced by the matched entities. Calculating the sensitivity index further includes generating, based on the regressing, a regression model to predict sensitivity values from the matched entities' attributes. Calculating the sensitivity index further includes predicting, based on the regression model, a sensitivity value of any entity of interest. Calculating the sensitivity index further includes predicting a first outcome for each matched entity under the first condition. Calculating the sensitivity index further includes predicting a second outcome for each matched entity under the second condition. Calculating the sensitivity index further includes calculating, based on the predicted first and second outcomes, a sensitivity index for each matched entity. Calculating the sensitivity index further includes subtracting the predicted first outcome under the first condition from the predicted second outcome under the second condition.

The first condition can include a stressed condition and the second condition can include a normal condition. The stressed condition can include one or more of: a recession, a depression, a change in debt, a change in job position, an injury, an accident, a marriage, a divorce, a new child, a change in interest rates, a change in a stock market, a change in debt, a change in credit balance, a new vehicle or home purchase, a severe weather event, a change in health insurance, an exam result, a change in residence, a change in diet, a change in expenses, enrollment in a coaching, or a change in income. The sensitivity index can include at least two segment values, the at least two segment values comprising a first sensitivity index value and a second sensitivity index value, wherein the first sensitivity index value indicates substantially no change in a probability of payment default, and wherein the second sensitivity index value indicates an increased probability of payment default. The sensitivity index for the first entity can include the second sensitivity index value, wherein the second risk score is lower than the first risk score. The method and/or operations can further include calculating a probability of repayment for the first entity based on the first risk score and the second risk score.

Implementations of the current subject matter can include, but are not limited to, systems and methods consistent including one or more features are described as well as articles that comprise a tangibly embodied machine-readable medium operable to cause one or more machines (e.g., computers, etc.) to result in operations described herein. Similarly, computer systems are also described that may include one or more processors and one or more memories coupled to the one or more processors. A memory, which can include a computer-readable storage medium, may include, encode, store, or the like one or more programs that cause one or more processors to perform one or more of the operations described herein. Computer implemented methods consistent with one or more implementations of the current subject matter can be implemented by one or more data processors residing in a single computing system or multiple computing systems. Such multiple computing systems can be connected and can exchange data and/or commands or other instructions or the like via one or more connections, including but not limited to a connection over a network (e.g. the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims. While certain features of the currently disclosed subject matter are described for illustrative purposes in relation to an enterprise resource software system or other business software solution or architecture, it should be readily understood that such features are not intended to be limiting. The claims that follow this disclosure are intended to define the scope of the protected subject matter.

### DESCRIPTION OF DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 is a diagram illustrating schematically the interplay of predictions, disruptions, and future payment performance, in accordance with aspects described herein;

FIG. 2 is a diagram illustrating how different consumers may react to different stress factors, in accordance with aspects described herein;

FIG. 3 is a diagram of a table illustrating economic sensitivity and balance change sensitivity, in accordance with aspects described herein;

FIG. 4 is a diagram of a table illustrating risk scores and economic sensitivity for a plurality of consumers, in accordance with aspects described herein;

FIG. 5 is a diagram of a scoring system utilizing a custom model predicting point estimates of repayment odds based on a risk score and other attribute values, in accordance with aspects described herein;

FIG. 6 is a diagram of a scoring system utilizing a custom model predicting scenario estimates of repayment odds based on a risk score, a recessionary risk score and other attribute values, in accordance with aspects described herein;

FIG. 7 is a diagram of a table illustrating different consumers associated with different risk scores based on their economic sensitivity index (ESI) values, in accordance with aspects described herein;

FIG. 8A is a diagram of a table illustrating different consumers associated with different risk scores and different balance change sensitivity values, in accordance with aspects described herein;

FIG. 8B is a diagram illustrating an exemplary decision tree lenders may use to incorporate sensitivities to make a credit card limit strategy, in accordance with aspects described herein;

FIG. 9 is a diagram of an individual's sensitivity with respect to two different conditions (e.g., a normal and stressed condition), in accordance with aspects described herein;

FIG. 10 is a time diagram that illustrates a longitudinal study design, in accordance with aspects described herein;

FIG. 11A is a diagram illustrating a difference between an average number of inquiries for the 20% most economic sensitive and the 20% least economic sensitive consumers within a risk score band, in accordance with aspects described herein;

FIG. 11B is a diagram illustrating a difference between an average total trade line balance for the 20% most economic sensitive and the 20% least economic sensitive consumers within a risk score band, in accordance with aspects described herein;

FIG. 11C is a diagram illustrating a difference between an average number of months since the most recent trade line for the 20% most economic sensitive and the 20% least economic sensitive consumers within a risk score band, in accordance with aspects described herein;

FIG. 11D is a diagram illustrating a difference between an average number of times 90 days past due for the 20% most economic sensitive and the 20% least economic sensitive consumers within a risk score band, in accordance with aspects described herein;

FIG. 12A is a diagram illustrating a difference between an average number of months since the oldest trade line opened for the 20% most balance change sensitive and the 20% least balance change sensitive consumers within a risk score band, in accordance with aspects described herein;

FIG. 12B is a diagram illustrating a difference between an average total revolving trade line balance for the 20% most balance change sensitive and the 20% least balance change sensitive consumers within a risk score band, in accordance with aspects described herein;

FIG. 12C is a diagram illustrating a difference between an average number of months since the most recent trade line for the 20% most balance change sensitive and the 20% least balance change sensitive consumers within a risk score band, in accordance with aspects described herein;

FIG. 12D is a diagram illustrating a difference between an average amount paid down on installment loans for the 20% most balance change sensitive and the 20% least balance change sensitive consumers within a risk score band, in accordance with aspects described herein;

FIG. 12E is a diagram illustrating a difference between an average number of times 90 days past due for the 20% most balance change sensitive and the 20% least economic sensitive consumers within a risk score band, in accordance with aspects described herein;

FIG. 13 is a diagram illustrating schematically the interplay of predictions, disruptions, and future entity behavior, in accordance with aspects described herein;

FIG. 14 depicts a block diagram illustrating a computing system, in accordance with aspects described herein; and

FIG. 15 is a flowchart of a method for segmenting a population based on sensitivities and a calculating risk score based on the segmented sensitivities, in accordance with aspects described herein.

When practical, similar reference numbers denote similar structures, features, or elements.

### DETAILED DESCRIPTION

This document describes a system and method to analyze entities and segment them based on their sensitivities to certain conditions. Using the sensitivity segments, a risk scoring system can better detect high default risk entities and more accurately predict entity future behavior. Further, the systems and methods described herein provide a mechanism for calculating sensitivity index values for entities.

Traditional risk scores predict future payment performance of entities (accounts, borrowers, consumers, small and medium sized enterprises) on their payment obligations. The scores are used by lenders and investors to group portfolios consisting of heterogeneous entities into score bands such that entities in any given band are homogeneous in expected future payment performance, and such that default odds vary substantially between score bands. The score bands are then managed and priced differentially according to their predicted default odds. For example a lender may entice the highest score bands (those with lowest predicted default odds) with low interest rates and high credit limits, charge higher interest rates and offer smaller limits to medium score bands, and deny credit for low risk score bands.

Risk scores are based on borrower attributes observed at scoring date and are developed with the objective to rank-order borrowers' expected future payment performances. The scores are also calibrated to predict borrowers' odds of default.

In some aspects, future substantial changes, or disruptions, to borrowers' situations following scoring date can have a substantial impact on payment performance that is not predicted by risk scores. As one consequence, such disruptions can lead to substantial discrepancies between predicted and actual future default odds. As another consequence, such changes can also reduce the rank ordering performance of the scores.

For example, for a given economic disruption, analysis of the resulting economic impact may indicate that actual default odds for a group of consumers in a homogeneous risk score band were substantially higher for a sub-group exposed after a scoring date to a recessionary economy, than for another sub-group exposed after the scoring date to a stable economy.

In another example, for a given disruption in financial obligations, analysis of the resulting economic impact may indicate that actual default odds for a group of consumers in a homogeneous risk score band were substantially higher for a sub-group who after a scoring date increased their credit card balances by substantial amounts (thereby increasing their financial obligations), than for another sub-group who after the scoring date did not increase their card balances by a substantial amount.

In some aspects, it may be desirable for lenders to identify those who are not in a financially robust situation if they face an unexpected, unavoidable cost for an expensive medical procedure, or another unexpected expense. There are many sources and types of disruptions that might have an impact on entities' loan repayment behavior, including, but not limited to: interest rate shocks, changes to income or employment status, changes to individuals' social relationships, property loss, accidents, injuries and illnesses, etc. In general it can be difficult, costly, and often quite impractical, to try to predict future disruptions with a high degree of confidence. Accordingly, it may be beneficial for a scoring system to account for future disruptions that are undetermined and unpredicted at a scoring date.

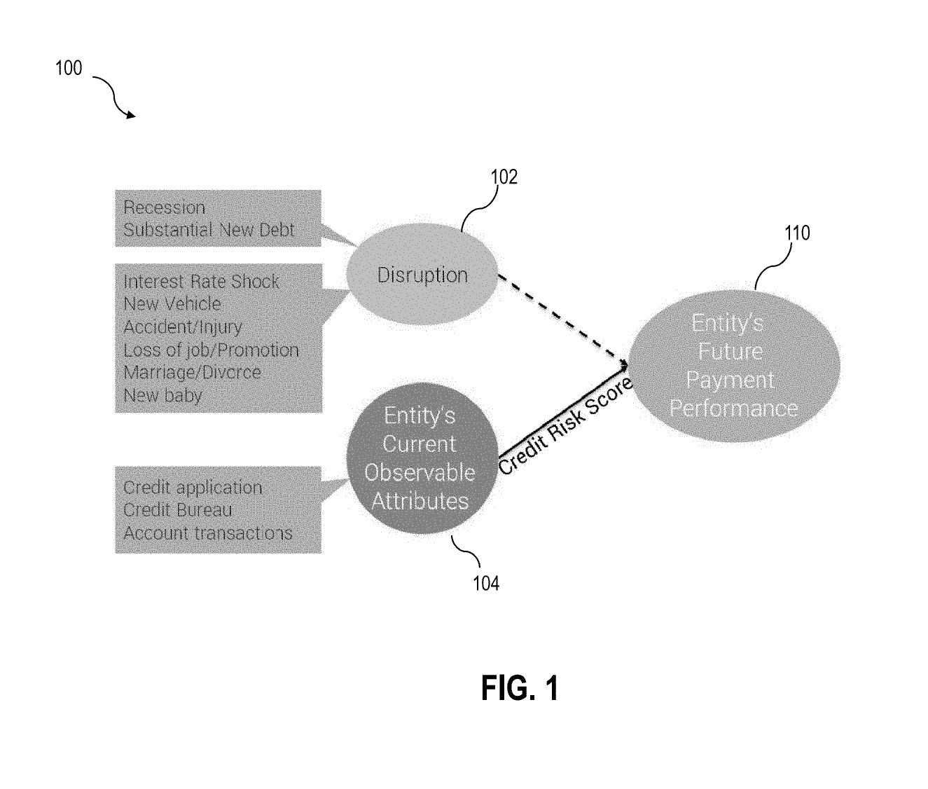

FIG. 1 is a diagram 100 illustrating schematically the interplay of predictions, disruptions, and future payment performance. A risk score inputs an entity's observable attributes 104 at a scoring date to predict the entity's future payment performance 110. The entity can include an individual, a group of individuals, a business entity, or other entity. A disruption 102 can impact the entity's future payment performance. The disruption 102 can include a recession, substantial new debt incurred, an interest rate shock, a new vehicle purchase, an accident/injury, loss of job, a promotion, a marriage, a divorce, a new child, or any other condition that may cause an impact on the entities financial or payment performance 110. As a consequence the risk score's prediction might misestimate future payment performance if a disruption occurs.

Disruption examples discussed herein relate to unfavorable changes to situations (e.g., tough economy, growing balances, medical expenses etc.), also referred to as “financial stress factors.” The disruptions and financial stress factors can apply equally to both positive or favorable disruptions (e.g. job promotion, inheritance, lottery win) as to negative or unfavorable disruptions. Typically an entity's payment performance is expected to worsen if an unfavorable disruption occurs, and the opposite might be expected when a favorable disruption occurs. However, it is possible that if an unfavorable disruption occurs, some entities' payment performance may not worsen and some may actually improve. For example, certain financially astute consumers might redouble their efforts to repay their debt when the economy worsens, or certain investors may derive gains from a recession. Similar, if a favorable disruption occurs, some entities' payment performance may not improve and some may actually worsen. For example, a lottery win may seduce certain individuals' to live above their means and eventually go bankrupt as a consequence.

Through improved modeling and analysis it is possible to gain insight into the variety of possible responses of entities to disruptions, without making any assumptions neither on the directional impact nor the magnitude of the effect of disruptions on individual entities' payment performances. Accordingly, the entity segmentation for analysis of economic sensitivity discussed herein may beneficially add flexibility and improved accuracy to current risk scoring models not previously available. The benefit occurs in at least segmenting heterogeneous entities into “sensitivity segments” based on a sensitivity to a disruption/condition to more accurately predict future payment performance. The entities in any given sensitivity segment can be similarly impacted by a certain type, or definition of, a disruption/condition.

Substantially worsening economic conditions, as exemplified by the Great Recession, and amassing debt, as exemplified by rapidly growing credit card balances, can be referred to as economic and financial stress factors. A consumer may or may not be exposed to a certain stress factor. Exposure to a stress factor may drive certain consumers to renege on their future credit obligations, whereas other consumers exposed to the same stress factor may hardly be affected. It may be beneficial to measure this effect to more accurately predict future payment performance and reflect that prediction in a risk score. In some implementations, a processor can implement a scoring system and create an ordinal scale of consumer sensitivities for each type, or definition, of a disruption or a stress factor. In some aspects, consumers can be ranked and segmented according to their sensitivities.

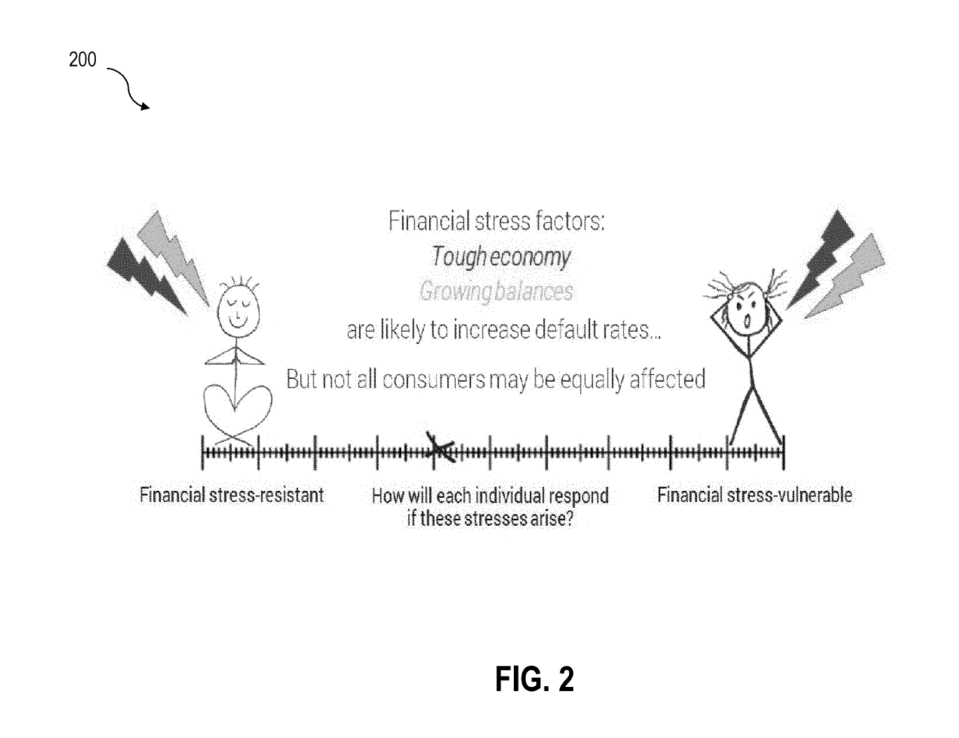

FIG. 2 is a diagram illustrating how different consumers may react to different stress factors. The left-hand side of the diagram represents consumers resilient and resistant to stress factors (e.g., low sensitivity) and the right-hand side of the diagram represents consumers vulnerable to stress factors (e.g., high sensitivity). Consumers can be located along the continuum between the two sides to indicate their relative response to stress factors. Consumers more to the left of the continuum can be less vulnerable and affected than consumers to the right of the continuum. As shown in FIG. 2, a consumer can be located at position 205 along the continuum slightly to the left of the halfway point between the two sides. Accordingly, the consumer located at position 205 may have a lower sensitivity than the medium or mean of consumers measured.

In some aspects, a scoring system may implement sensitivity scales (e.g., ordinal scales) to group consumers into sensitivity segments. For example, all US consumers with access to credit can be arranged into 3 economic sensitivity segments labeled “Low”, “Medium” and “High”, each segment containing 33% of the population. The economic sensitivity segments can be allocated by rank ordering the consumers from the lowest ordinal economic sensitivity to the highest, then designating the first 33.33% to the “Low” segment, the next 33.33% to the “Medium” segment, and the final 33.33% to the “High” segment. In an analogous manner, credit card balance change sensitivity segments, or segments pertaining to other types of disruptions, can be constructed.

While three economic sensitivity segments based on distribution terciles are described herein, any number of segments can be generated as desired with lesser or finer granularities and possibly non-equal segment proportions. Segmentations with finer granularities can also be constructed by incorporating other variables into the segment definitions. For example the sub-population grouped within the FICO® Score band from 678 to 682 (or any other sub-population score band of interest) could be further sub-segmented into sensitivity quintiles obtained from the distribution of sensitivities within the particular score band of interest.

Having constructed stress-sensitivity segments for various types of disruptions, entities (e.g., consumers) can be more deeply and more easily understood and managed in terms of the risks they pose to lenders, by not only taking into account their risk scores such as the FICO® score, but in addition, also calling out the extra risks due to impacts of possible future disruptions. These extra risks increase for consumers who are more sensitive to disruptions.

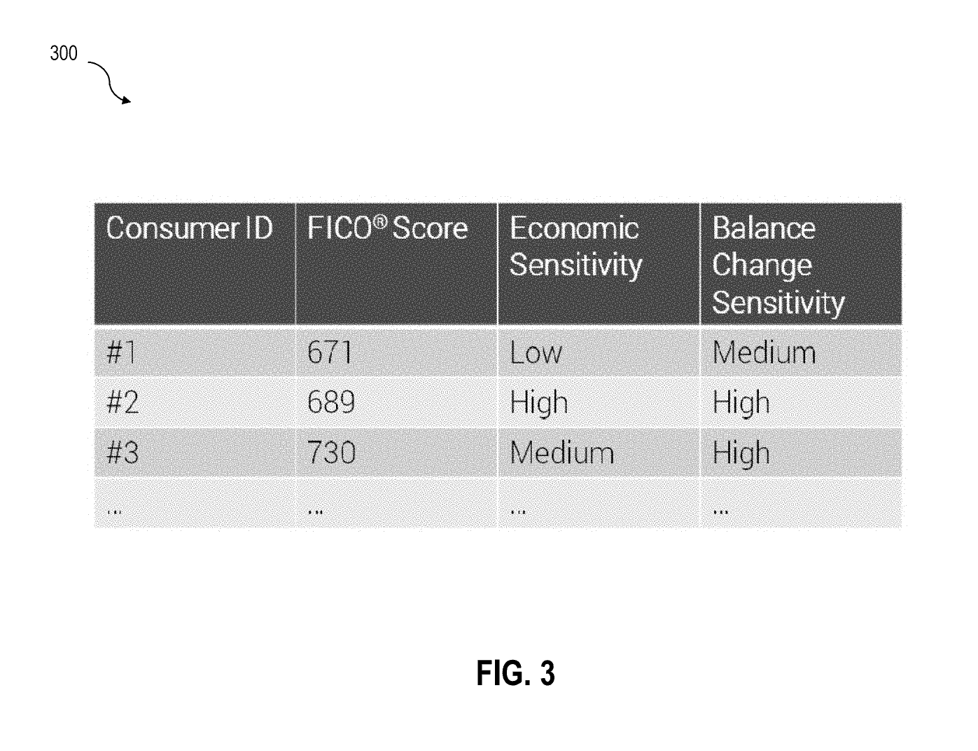

FIG. 3 is a diagram of a table 300 illustrating economic sensitivity and balance change sensitivity. As shown, consumer economic sensitivity and consumer balance change sensitivity are segmented into three segments (High, Medium, and Low). In some aspects, economic sensitivity measures consumer sensitivity (e.g., payment performance) to economic stress factors such as a recession, depression, high inflation, or the like. In some aspects, consumer balance change sensitivity measures consumer sensitivity to credit balance changes. For example, consumers who increase their likelihood of defaulting in response to a substantial credit card balance increase may be allocated to the High credit card balance sensitivity segment.

Knowledge of consumer sensitivities can enable lenders to take mitigating actions in order to reduce total risk, which arises in part is due to unpredicted disruptions. As an example, a lender worried about the next recession might reduce exposure to consumers with high economic sensitivities and increase exposure to consumers with low economic sensitivities. The lender might consider combinations of FICO® Score values (or other risk score values) and economic sensitivity segments to create preference rankings whereby a consumer with a marginally lower FICO® Score yet a favorably low economic sensitivity might be preferred over a consumer with slightly higher FICO® score yet an unfavorably high economic sensitivity. Preferences might be expressed through marketing targeting, through accepting or rejecting a credit line request, through settings of loan limits, through pricing, etc.

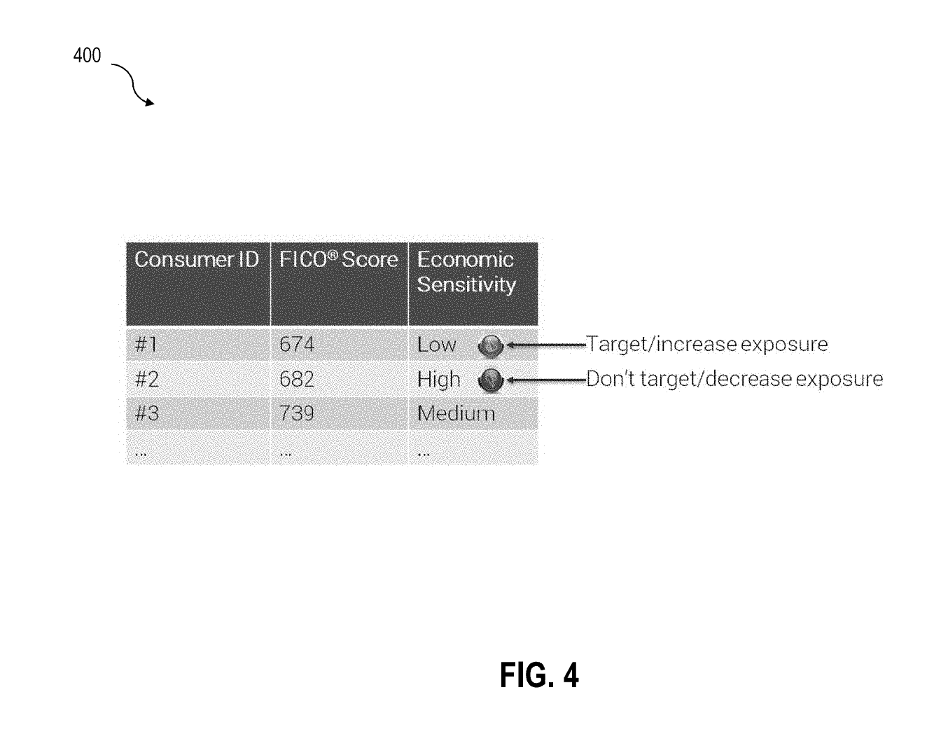

FIG. 4 is a diagram of a table 400 illustrating risk scores and economic sensitivity for a plurality of consumers. As shown in FIG. 4, consumer #1 has a risk score of 674 and a Low economic sensitivity index (ESI). Consumer #2 has a risk score of 682 and a High ESI. In some aspects, while consumer #1 has a lower risk score than consumer #2, a lender may prefer consumer #1 over consumer #2 because consumer #1 has a Low ESI and may be more resilient and less sensitive to negative economic stress factors and/or disruptions. In some implementations, a processor may display an icon, button, alert, or other indication on a user interface to indicate that the consumer has a favorable or unfavorable ESI. As shown in FIG. 4, consumers with a Low ESI are indicated by a green “thumbs up” icon while consumers with a High ESI are indicated by a red “thumbs down” icon.

In some implementations, lenders can use the consumer risk score (e.g., FICO® Score), along with other attributes, as inputs to custom models which produce point estimates of repayment odds for particular products, such as a mortgages, installment loans, auto loans or credit cards.

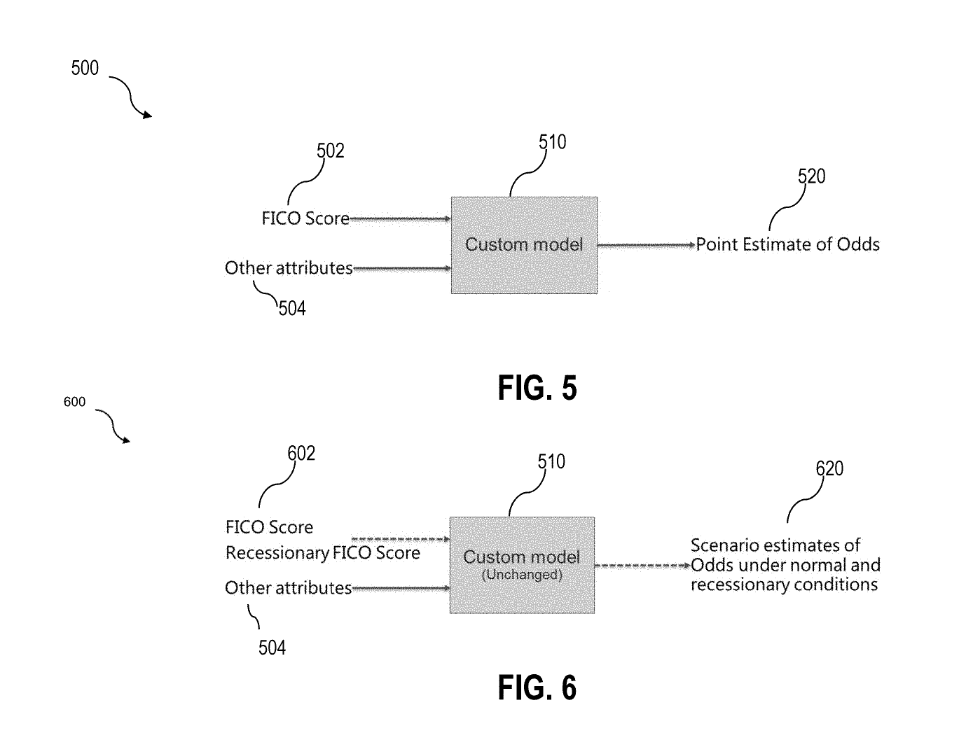

FIG. 5 is a diagram of a scoring system 500 utilizing a custom model 510 predicting point estimates 520 of repayment odds based on a risk score 502 and other attribute values 504. In some aspects, the other attribute values 504 can include delinquency history, current income, length of employment, or other information about the consumer obtained by the lender to help make a lending decision.

These lenders can expand the use of their custom models to not only produce point estimates of odds but also to generate stressed scenario estimates of odds. This can be achieved by switching the “normal” risk score 502 (e.g., FICO® Score) input to a “Recessionary Risk Score” (e.g., Recessionary FICO® Score).

FIG. 6 is a diagram of a scoring system 600 utilizing the custom model 510 predicting point estimates 620 of repayment odds based on a recessionary risk score 602 and other attribute values 504. The recessionary risk score 602 (e.g., Recessionary FICO® Score) is a recalibrated version of the “normal” risk score 502 that is adjusted to a recession in a manner that is highly individualized to consumers' economic stress sensitivities. The recessionary risk score 602 can further be adjusted according to an assumed severity of a recession.

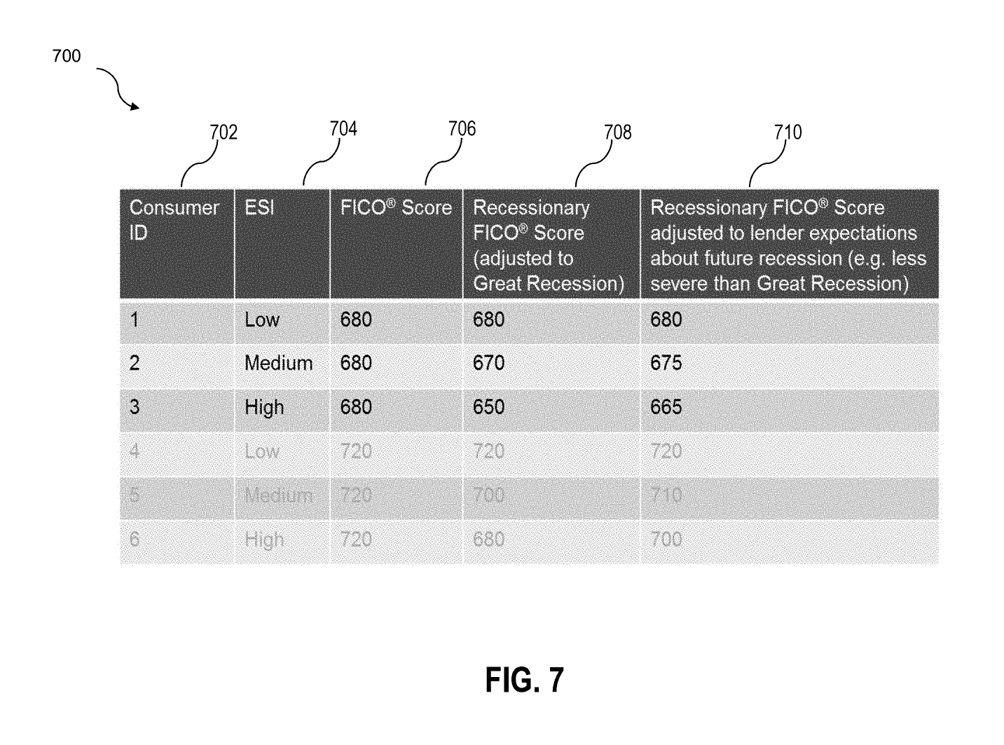

FIG. 7 is a diagram of a table 700 illustrating different consumers associated with different risk scores based on their economic sensitivity index (ESI) values. Column 702 comprises consumer identifiers, column 704 comprising ESI values for the consumers, column 706 comprises “normal” risk scores (e.g., FICO® scores), column 708 comprises a first recessionary risk score (e.g., first recessionary FICO® score), and column 710 comprises a second recessionary risk score (e.g., second recessionary FICO® score. As shown in FIG. 7, consumer 1 can be associated with a FICO® Score of 680 and with a Low economic sensitivity index (ESI) value. Through the use of a risk scoring model, the consumer can be assigned first and second recessionary FICO® Scores of 680 (e.g., recession has no impact on a consumer with Low economic sensitivity) based on the Low ESI value and the normal risk score of 680. However, consumer 3 can also be associated with a FICO® Score of 680 but with a High ESI value. The risk scoring model can assign a first recessionary FICO® Score of 650 based on the High ESI value. In this example, the first recessionary FICO® Scores in column 708 were calibrated to the last US recession (the so-called Great Recession.) A lender may have different expectations about a future recession, for example that it will be less severe than the Great Recession, and calculate the second recessionary FICO® Scores in column 710. As shown in FIG. 7, consumer 3 can be assigned a second recessionary FICO® Score of 665 accordingly to deviate less from the FICO® Score 680 than the scenario for the first recessionary FICO® Score of 650 (e.g., for the Great Recession).

In other implementations, a credit card lender worried about affordability of future card balances might extend more conservative limits to (or seek to decrease limits for) consumers in high balance change sensitivity segments while extending more aggressive limits to consumers with low balance change sensitivity. The lender might consider combinations of risk score (e.g., FICO® Score) values and balance change sensitivity segments to create new swap sets whereby a consumer with a marginally lower risk score but a favorable low balance change sensitivity might be preferred over a consumer with slightly higher risk score but unfavorable high balance change sensitivity.

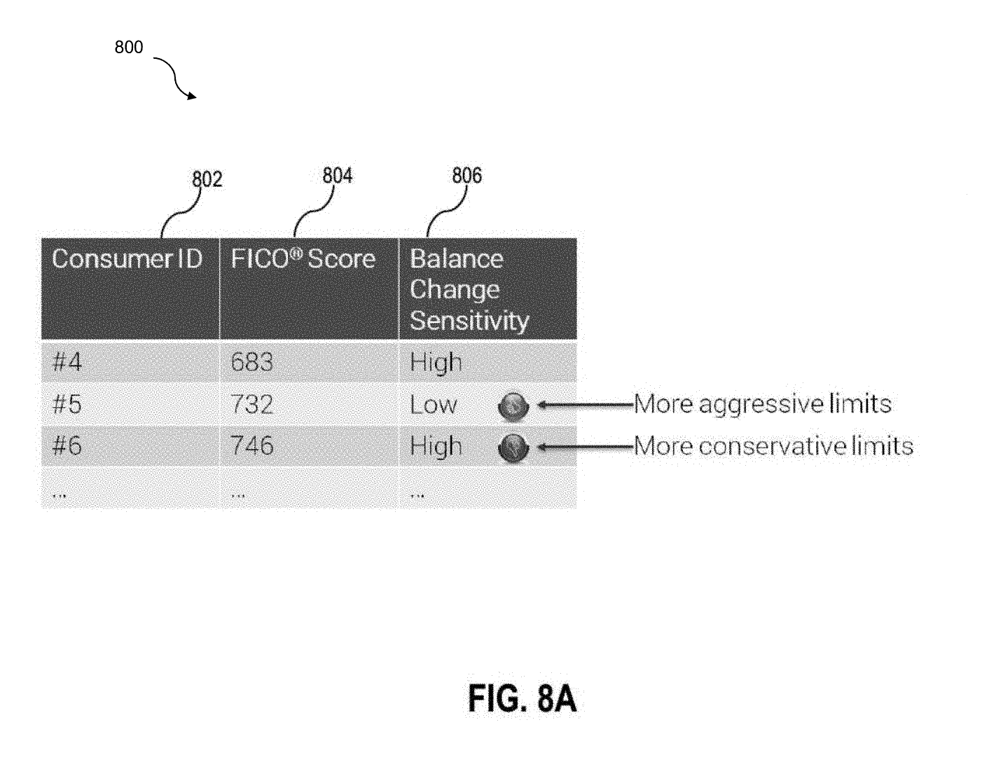

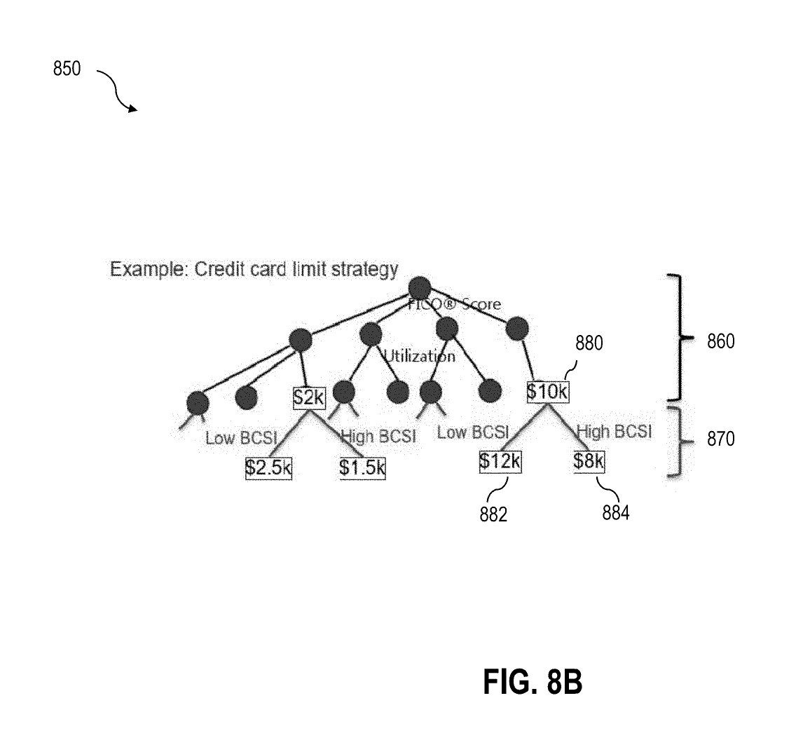

FIG. 8A is a diagram of a table 800 illustrating different consumers associated with different risk scores and different balance change sensitivity values. Column 802 comprises consumer identifiers, column 804 comprises risk scores (e.g., FICO® scores), column 806 comprises balance change sensitivity values. As shown in FIG. 8A, consumer #5 has a risk score of 732 and a Low balance change sensitivity rating. Consumer #6 has a risk score of 746 and a High balance change sensitivity rating. In some aspects, while consumer #5 has a lower risk score than consumer #6, a lender may prefer consumer #5 over consumer #6 because consumer #5 has a Low balance change sensitivity rating and may be more resilient and less sensitive to negative economic stress factors and/or disruptions.

In some aspects, a lender can combine different sensitivity segments and apply them in a customized model in order to better predict future performance or target certain consumers. For example, a credit card lender worried about both a possible future recession and the affordability of additional credit card balances, might create combinations of associated sensitivity segments, and design different card limit treatments for each segment combination. For example, Table 1 below illustrates different treatments the lender may apply to consumers associated with different combinations of economic sensitivity values and balance change sensitivity values. As shown in Table 1, a consumer with a “Low” economic sensitivity and balance change sensitivity values may receive a large credit limit increase while a consumer with both “High” economic sensitivity and balance change sensitivity values may receive a decrease in their credit limit.

TABLE 1

| Segment combination | Treatment |
|---|---|
| Economic Sensitivity = ‘Low’ and | Large increase |
| Balance Change Sensitivity = ‘Low’ | |
| Economic Sensitivity = ‘Low’ and | Medium increase |
| Balance Change Sensitivity = ‘Medium’ | |
| Economic Sensitivity = ‘Low’ and | Small increase |
| Balance Change Sensitivity = ‘High’ | |
| Economic Sensitivity = ‘Medium’ and | Small increase |
| Balance Change Sensitivity = ‘Low’ | |
| Economic Sensitivity = ‘Medium’ and | No increase |
| Balance Change Sensitivity = ‘Medium’ | |
| Economic Sensitivity = ‘Medium’ and | Seek decrease |
| Balance Change Sensitivity = ‘High’ | |
| Economic Sensitivity = ‘High’ and | No increase |
| Balance Change Sensitivity = ‘Low’ | |
| Economic Sensitivity = ‘High’ and | Seek decrease |
| Balance Change Sensitivity = ‘Medium’ | |
| Economic Sensitivity = ‘High’ and | Seek decrease |
| Balance Change Sensitivity = ‘High’ | |

Sensitivity segments might also be used in conjunction with risk scores and may be further refined based on other attributes and scores, such as delinquency history and customer revenue scores, to further differentiate and treatments between different types of consumers. Lenders using decision tree technology to map entities' attribute values 504 and risk scores (e.g., risk scores 502 and/or 602) to treatments can enhance their set of decision keys by the new sensitivity segments (e.g., economic sensitivity and/or balance change sensitivity segments) in order to capitalize on them when designing improved treatment strategies.

FIG. 8B is a diagram 850 illustrating an exemplary decision tree lenders may use to incorporate sensitivities to make a credit card limit strategy, in accordance with aspects described herein. Lenders can use these decision trees as “strategies” or “policies” to map value ranges of risk scores and/or other attributes to segments of entities that will receive different treatments. These decision rules and mappings from risk scores and attributes to treatments, can be refined by adding sensitivity indices as additional inputs into the strategies. As shown in FIG. 8B, a credit card balance change sensitivity index (BCSI) can be included an additional layer to make a credit card limit strategy (represented as a decision tree here) more robust. The lender's current strategy 860 may consider the FICO® Score and a card utilization to assign limit increases. For example, as shown at node 880, a customer with a high FICO Score and high utilization may receive a $10,000 increase with the current strategy 860. With the additional input of a consumer's BCSI, the lender can refine the strategy with an addition layer 870. For example, the lender can alter limit decisions by considering balance change sensitivity. For example, consumers with high FICO Score, high utilization, and a High balance change sensitivity, can receive only a $8,000 increase (node 884), whereas consumers with high FICO Score, high utilization, and a Low balance change sensitivity, can receive a $12,000 increase (node 882).

In some implementations, population and portfolio distributions of risk scores such as the FICO® Score are tracked and used by regulators and investors to assess the relative vulnerability of populations of entities such as loan portfolios and securitized assets over the economic cycle. Similarly, tracking distributions of sensitivities to financial stress factors or other disruptions can inform regulators and investors about extra risks due to possible future disruptions that risk scores may not capture. These sensitivities can beneficially provide a way to monitor and assess the relative vulnerability of loan portfolios and securitized assets due to the economic cycle and/or due to balance growth, and could form an input into portfolio “stress testing.”

For sensitivity monitoring, either the proportions of a population or portfolio across sensitivity segments defined based on ordinal sensitivity scale break points can be tracked, or ordinal sensitivity estimates can be used to calculate summary statistics (means and variances) of ordinal sensitivity segments across portfolios.

In some aspects, it is possible to define an entity's sensitivity to a disruption or stress factor in the framework of the Rubin causal model, as the difference between potential payment performances for the entity when subjected to alternative situations or conditions, namely a “normal” condition and a “stressed” condition. As such, an entity's sensitivity is an individual-level causal effect of a binary condition on future payment performance. In this framework, normal and stressed conditions appear as two arms of a thought experiment. In reality an entity can only travel along one arm of the experiment for which the entity's performance is then observed. Performance for the untraveled arm cannot be observed.

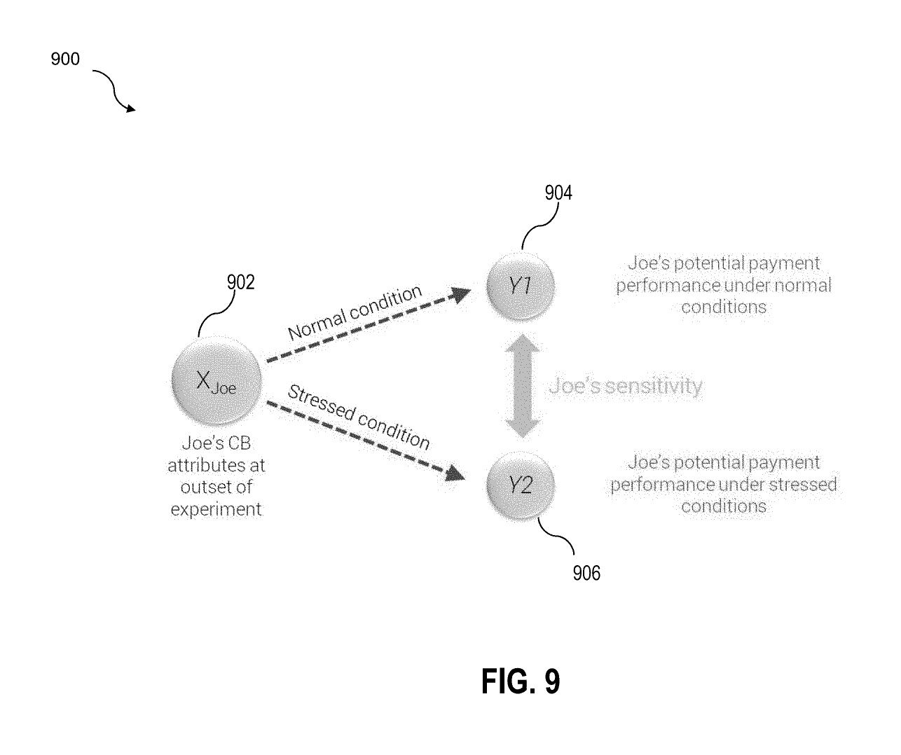

FIG. 9 is a diagram 900 of an individual's sensitivity under two different conditions (e.g., a normal and stressed condition). As shown, in FIG. 9, the individual, X_{Joe} 902, can have can have certain attribute values at the outset of an experiment, also referred to as the “scoring date.” The experiment attempts to predict Joe's payment under two different conditions, a normal condition and a stressed (e.g., economic recession or downturn) condition. At the end of the experiment, the individual's (Joe's) potential payment performance under normal conditions is represented as Y1 904 and Joe's potential payment performance under stressed conditions is represented as Y2 906. Joe's sensitivity to the stressed condition (e.g., disruption or stress factor) can be defined based on the difference between Y1 904 and Y2 906.

Expanding from the example of FIG. 9, in some aspects, if certain statistical and econometric conditions hold on a sample of development data consisting of entities' attributes at a scoring date and of the experimental conditions subject to which entities' performances were observed, then it is possible to estimate individual-specific causal effects on ordinal scales. In some implementations, estimating sensitivities to financial stress factors or other disruptions as individual-specific causal effects, can leverage natural experiments in a transparent and fail-safe manner.

For example, a method of estimating individual economic sensitivities can include a first step of determining if there are a sufficient number of entities that share the same or similar attribute values at scoring date yet subsequently travel through different arms of the experiment. For example, if a large number of entities share one or more attribute values or similar attribute values (e.g., income, payment history, outstanding balances, number of inquiries, etc.), and those entities also experience different disruptions or stress factors (e.g., half undergo normal conditions and half undergo stressed condition). In some aspects, determining which entities share the same or similar attribute values can be based on a propensity score. In some implementations the propensity score can be calculated using any propensity score matching technique. For example, a propensity score can be calculated using a technique described in the publication “The Central Role of the Propensity Score in Observational Studies for Causal Effects” Biometrika 70 (1): 41-55, (1983) by Paul Rosenbaum and Donald Rubin.

If the answer is ‘no’ then sensitivity estimation cannot be accomplished with confidence (fail-safe). If the answer is ‘yes’, then a sensitivity estimating system may, in a second step, create a matched sample of entities where a first sub-population of entities travels along the normal condition arm and a second sub-population of other entities travels along the stressed condition arm, such that the two sub-populations are similar in their attribute distributions at the scoring date.

Next, in a third step, the sensitivity estimating system can define predictors comprised of the matched entities' attributes at the scoring date and a binary (0/1 for “normal”/“stressed”) indicator variable. The sensitivity estimating system can use supervised machine learning techniques to regress the entities' observed performances based on these predictors. In a fourth step, for each matched entity, the sensitivity estimating system can predict expected entities' performances under normal and under stressed conditions, by varying the value of the binary indicator variable (e.g., predictors defined in the third step) from 0 to 1, while keeping the entity's attributes fixed. Compute sensitivity value (e.g., Low, Medium, High) of each matched entity by differencing normal and stressed predictions.

In a fifth step, the sensitivity estimating system can use supervised machine learning techniques to regress the entities' sensitivity values based on the entities' observable attributes at the scoring date. For example, the regression may indicate that entities in at a certain income group have a higher sensitivity than entities in a different income group. In a sixth step, the sensitivity estimating system can use the regression model from the fifth step to predict the sensitivities of any entities of interest. The entities of interest referred to the sixth step can be new entities, such as new customers, or they can be existing entities whose attribute values may change over time, thus allowing sensitivities of entities, which need not to remain constant over time, to be regularly updated based on the latest data available on the entities. For example, a new customer can have certain attribute values that match with, or are similar to, other entities used in the sensitivity estimating system that had a Low economic sensitivity index (ESI). Accordingly, the new customer may also be assigned a Low ESI.

In some implementations, a proof-of-concept model for economic sensitivity described herein can be based on US credit bureau data collected during two starkly contrasting phases of the recent US economic cycle. Payment performance for a stable economy (“normal condition”) can be collected during the 2-year window starting with scoring date October 2013 and ending October 2015. Payment performance for a recessionary economy (“stressed condition”) can be collected during the 2-year window starting with scoring date October 2007 and ending October 2009 which falls into the time of the Great Recession. The binary (“normal”/“stressed”) indicator was accordingly defined as: ‘0’ for a first group of consumers whose attributes were collected in October 2013 and who subsequently performed under normal conditions; and ‘1’ for a second group of consumers whose attributes were collected in October 2007 and who subsequently performed under stressed conditions.

In some aspects, a proof-of-concept model for credit card balance change sensitivity described herein can be based on US credit bureau data collected and combined from multiple scoring dates across a recent economic cycle, including both stable and recessionary performance periods. In this way, the balance change sensitivity model is not tied to a specific economic condition but captures averaged behaviors from across various economic conditions. Payment performance for “non-increasers” (“normal condition”) was collected for consumers who didn't increase their card balances by more than $100, or decreased their card balances, over a “balance change window” of 6 months following a scoring date. Payment performance for “increasers” (“stressed condition”) was collected for consumers who increased their card balances by more than $2,000 over the balance change window. In all cases, payment performance was collected over a 2-year window following the balance change window.

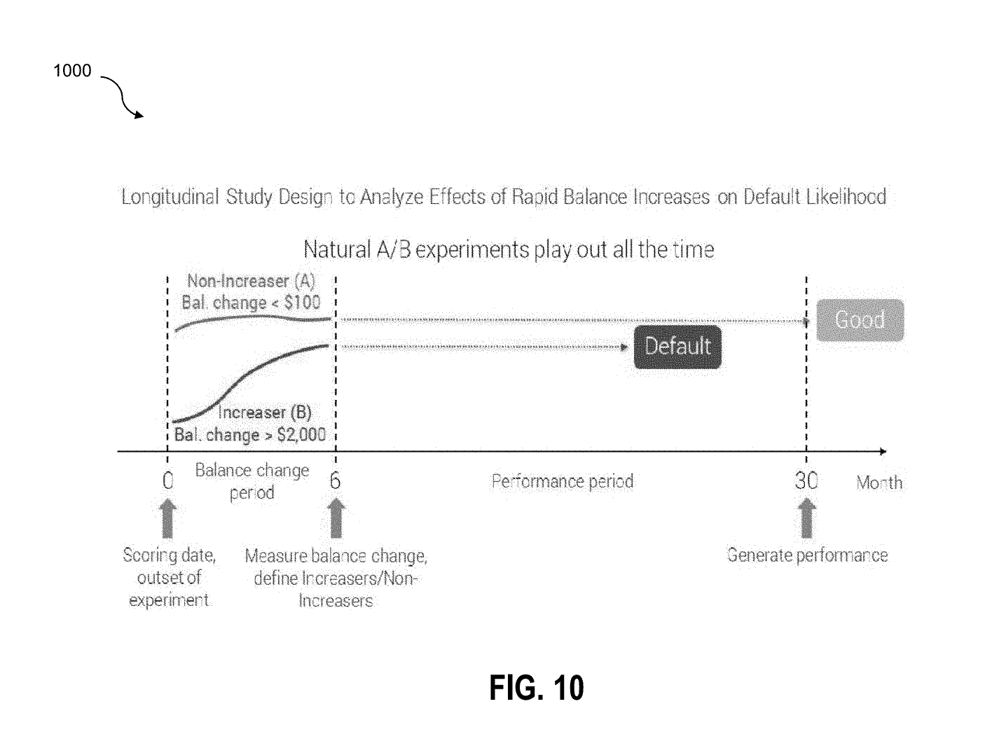

FIG. 10 is a time diagram 1000 that illustrates this longitudinal study design. The binary (“normal”/“stressed”) indicator was accordingly defined as: ‘0’ for a first group of consumers who didn't increase their card balances by more than $100, or decreased their card balances, over the balance change window, with their performances observed under these “normal” conditions; and ‘1’ for a second group of consumers who increased their card balances by more than $2,000 over the balance change window, with their performances observed under these “stressed” conditions. As shown in FIG. 10, month 0 is the scoring date which begins the experiment. The two groups are represented as two lines, the first group is the top line 1010 and the second group is represented by the bottom line 1020. At month 6, the study can measure the credit balance change for all participants and define the two groups (e.g., define the two lines 1010 and 1020). During months 6-30 (“performance period”), the study can measure the performance of the two groups over time. At month 30, the study can perform an analysis of the two groups over the performance period and generate payment performance statistics based on the analysis.

During both model developments (e.g., economic sensitivity and balance change sensitivity) the study found sufficient numbers of entities that shared similar attribute values at the scoring date (month 0) and subsequently traveled through different arms of their experiments, (i.e. performed under “normal” and under “stressed” conditions). The study then used supervised machine learning techniques to regress the entities and calculated the economic sensitivities and the balance change sensitivities based on the entities' observable attributes at the scoring date for a large and representative sample of US consumers who regularly access consumer credit.

From the regression analysis performed at the end of the performance period it is possible to gain deep and valuable insights from understanding the calculated sensitivities. After determining the entities' economic sensitivities and balance change sensitivities, it can be beneficial to generate and profile a few exemplary sensitivity segments. In some aspects, it is possible to create sensitivity segments for an illustrative sub-population of consumers within a risk score (e.g., FICO® score) band. For example, FIGS. 7A-7C and FIGS. 8A-8D, illustrate considerable heterogeneity of consumers and their behaviors found even within a narrow risk score band which would traditionally be regarded as a homogeneous risk score pool. It may be beneficial for lenders to exploit this heterogeneity to create sensitivity sub-segments within homogeneous risk score pools that differ with respect to their sensitivities to disruptions. By segmenting consumers with similar risk scores based on their sensitivities, lenders and models can beneficially capture wider aspects of risk that are not captured by typical risk scores.

In a non-limiting example, it is possible to analyze entities that fall within a given risk score band (e.g., the FICO® Score band from 678 to 682). A model can further sub-segment the entities into economic sensitivity quintiles based on the distribution of economic sensitivities within this FICO® Score band. In the illustrative example, the risk score band (FICO® Score band from 678 to 682) is relatively narrow, such that from the traditional risk scoring perspective, this sub-population of entities would be regarded as a homogeneous risk pool. However, as illustrated below, the lowest and the highest economic sensitivity quintile segments can differ substantially in their attribute distributions.

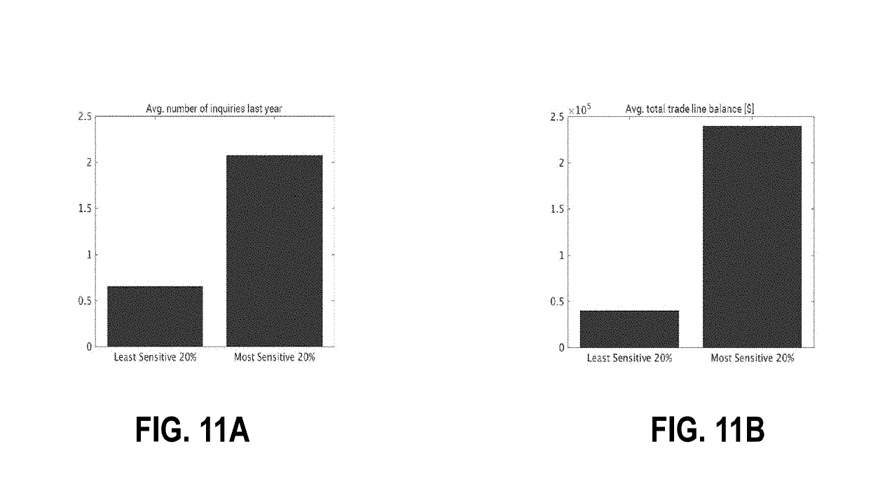

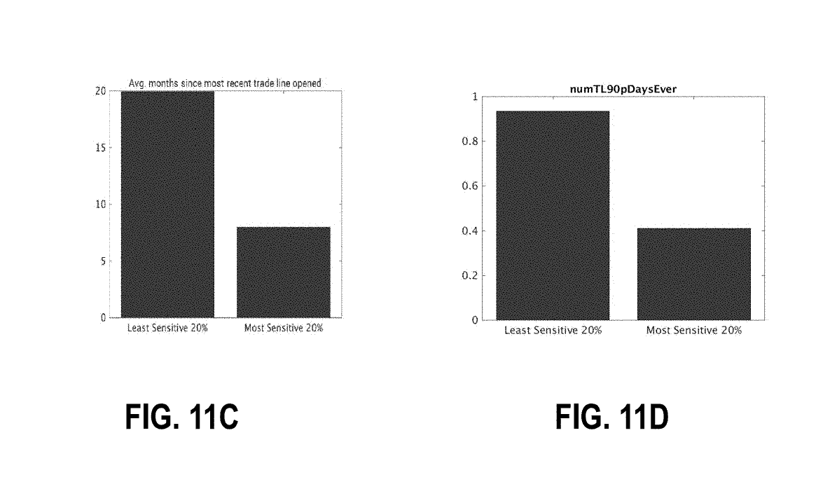

FIG. 11A is a diagram illustrating a difference between an average number of inquiries for the 20% most economic sensitive and the 20% least economic sensitive consumers within the risk score band of 678 to 682. FIG. 11B is a diagram illustrating a difference between an average total trade line balance for the 20% most economic sensitive and the 20% least economic sensitive consumers within the risk score band of 678 to 682. FIG. 11C is a diagram illustrating a difference between an average number of months since the most recent trade line for the 20% most economic sensitive and the 20% least economic sensitive consumers within the risk score band of 678 to 682. FIG. 11D is a diagram illustrating a difference between an average number of times 90 days past due for the 20% most economic sensitive and the 20% least economic sensitive consumers within a risk score band, in accordance with aspects described herein.

As shown in FIGS. 11A-D, having more credit inquiries, having higher trade line balances, having more recently a new trade line opened, and having lower average number of times 90 days past due, are all associated with having higher economic sensitivity.

Empirically, data analysis can find that the default rate more than doubles during the stressed economic period versus the normal economic period for the 20% most sensitives in a given score band, whereas the default rate may hardly vary across economic conditions for the 20% least sensitives in this score band. Such information can be useful to companies deciding between consumers with similar risk scores but different economic sensitivity scores.

Similarly, the sub-population within the FICO® Score band from 678 to 682 may be further sub-segmented, or alternatively sub-segmented, into balance change sensitivity quintiles based on the distribution of economic sensitivities within this FICO® Score band. In the illustrative example, the risk score band (FICO® Score band from 678 to 682) is relatively narrow, such that from the traditional risk scoring perspective, this sub-population of entities would be regarded as a homogeneous risk pool. However, as illustrated below, the lowest and the highest balance change sensitivity quintile segments differ substantially in their attribute distributions.

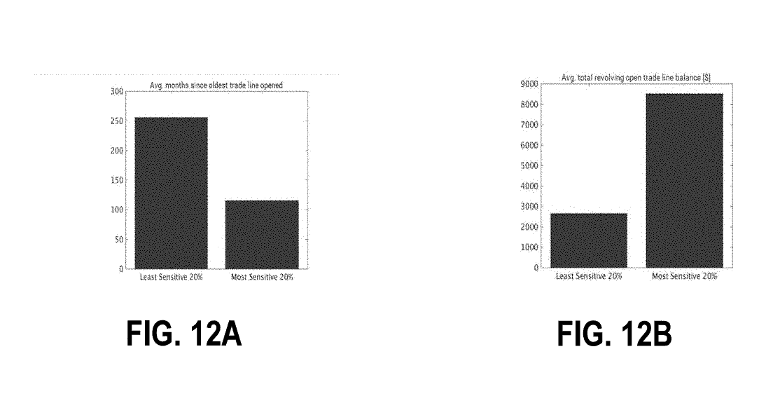

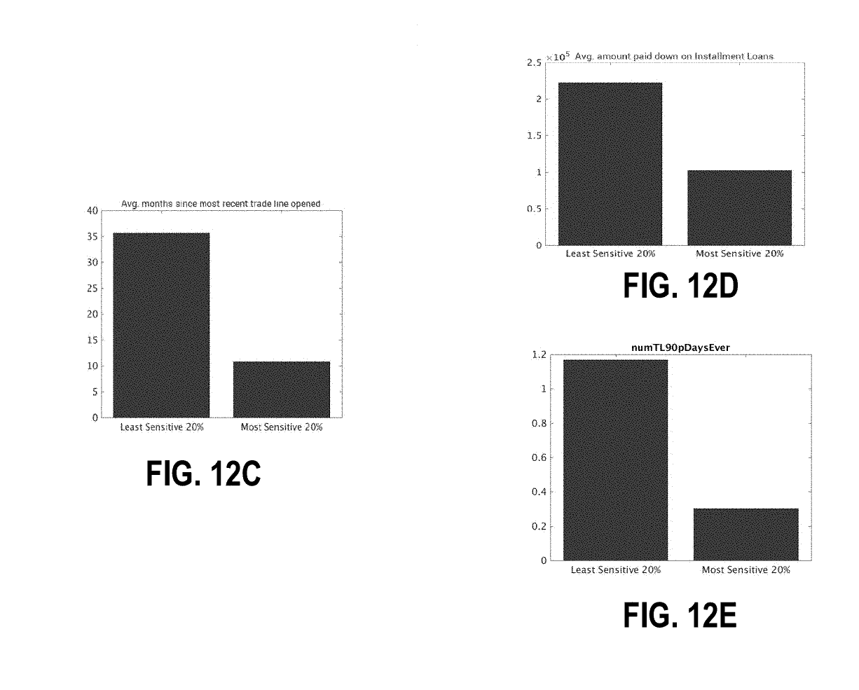

FIG. 12A is a diagram illustrating a difference between an average number of months since the oldest trade line opened for the 20% most balance change sensitive and the 20% least balance change sensitive consumers within the risk score band of 678 to 682. FIG. 12B is a diagram illustrating a difference between an average total revolving trade line balance for the 20% most balance change sensitive and the 20% least balance change sensitive consumers within the risk score band of 678 to 682. FIG. 12C is a diagram illustrating a difference between an average number of months since the most recent trade line for the 20% most balance change sensitive and the 20% least balance change sensitive consumers within the risk score band of 678 to 682. FIG. 12D is a diagram illustrating a difference between an average amount paid down on installment loans for the 20% most balance change sensitive and the 20% least balance change sensitive consumers within the risk score band of 678 to 682. FIG. 12E is a diagram illustrating a difference between an average number of times 90 days past due for the 20% most balance change sensitive and the 20% least balance change sensitive consumers within the risk score band of 678 to 682.

As shown in FIGS. 12A-E, having less maturation time of oldest credit line, having higher revolving balances, having more recently a new trade line opened, having made lower down payments on installment loans, and having lower average number of times 90 days past due, are all associated with having higher balance change sensitivity.

Empirically, data analysis can find that the default rate varies considerably more across balance stress conditions for the 20% most balance change sensitive consumers than for the 20% least balance change sensitive consumers in a given score band. Such information can be useful to companies deciding between consumers with similar risk scores but different balance change sensitivity scores.

While economic and balance change sensitivities are described herein, it is possible to calculate other consumer sensitivities. For example, sensitivity scores can reflect the interplay between predictions of any kinds of behaviors of entities (not necessarily their future payment performance, and predictions not necessarily based on credit bureau data), disruptions of any kind (as long as data on the disruptions are collected), and entities' actual future behaviors. In some aspects, consumers could be segmented into groups that differ in terms of impact of health insurance loss on future investment decisions, or groups that differ in terms of impact of adopting a cholesterol-lowering medication on future levels thereof, or groups that differ in terms of impact of enrollment in a driver education program on future driving skills, etc.

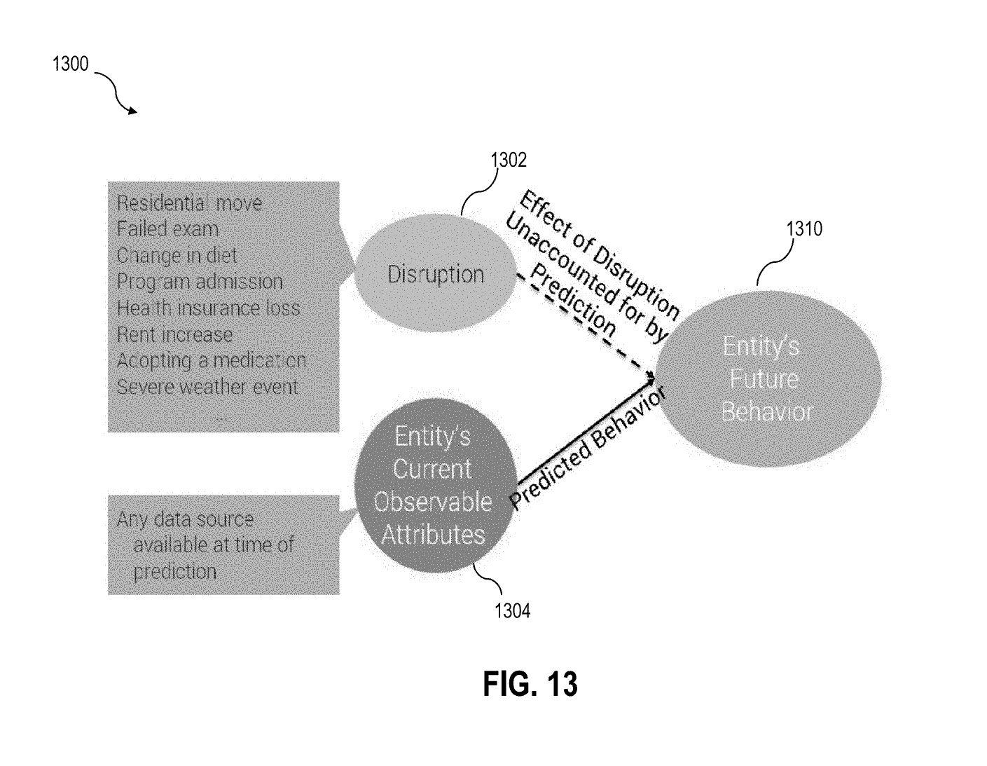

FIG. 13 is a diagram 1300 illustrating schematically the interplay of predictions, disruptions, and future entity behavior. As illustrated in FIG. 13, a predictive model may base its prediction 1310 of an entity's future behavior on a variety of data sources and data attributes 1304 associated with the entity at a certain time. The model may also consider sensitivities to a variety of disruptions 1302 to determine an effect of a given disruption to the entity that would otherwise be unaccounted for by the predictive model.

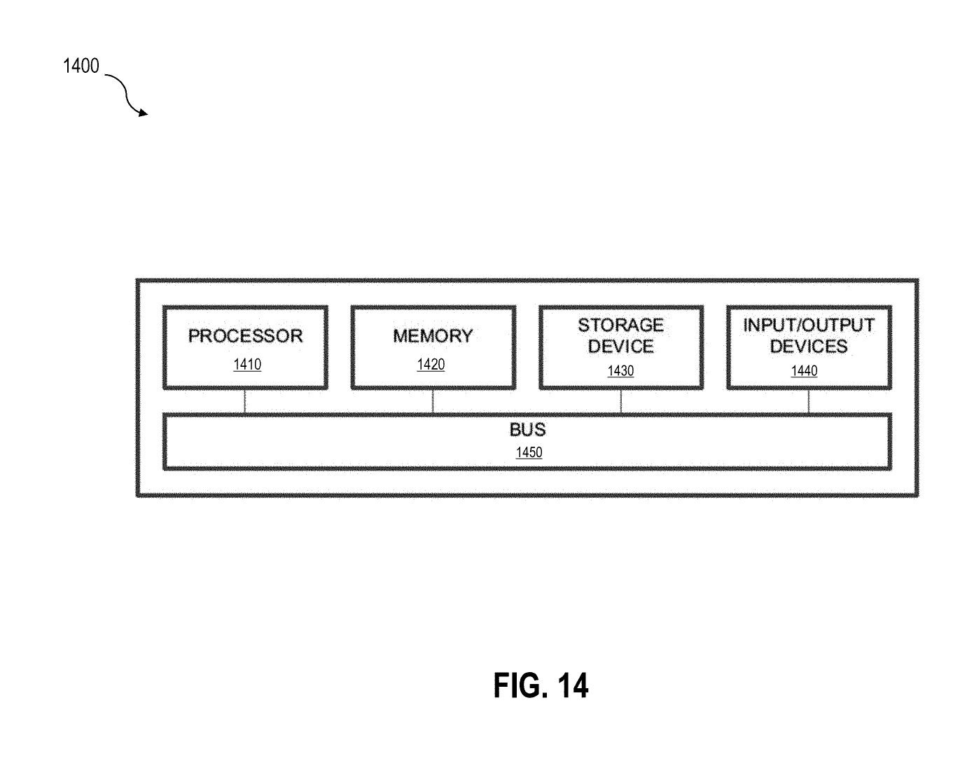

FIG. 14 depicts a block diagram illustrating a computing system 1400, in accordance with some example embodiments.

As shown in FIG. 14, the computing system 1400 can include a processor 1410, a memory 1420, a storage device 1430, and input/output devices 1440. The processor 1410, the memory 1420, the storage device 1430, and the input/output devices 1440 can be interconnected via a system bus 1450. The processor 1410 is capable of processing instructions for execution within the computing system 1400. Such executed instructions can implement one or more components of, for example, the decision management platform 110. In some implementations of the current subject matter, the processor 1410 can be a single-threaded processor. Alternately, the processor 1410 can be a multi-threaded processor. The processor 1410 is capable of processing instructions stored in the memory 1420 and/or on the storage device 1430 to display graphical information for a user interface provided via the input/output device 1440.

The memory 1420 is a computer readable medium such as volatile or non-volatile random-access memory (RAM) that stores information within the computing system 1400. The memory 1420 can store data structures representing configuration object databases, for example. The storage device 1430 is capable of providing persistent storage for the computing system 1400. The storage device 1430 can be a floppy disk device, a hard disk device, an optical disk device, or a tape device, or other suitable persistent storage means. The input/output device 1440 provides input/output operations for the computing system 1400. In some implementations of the current subject matter, the input/output device 1440 includes a keyboard and/or pointing device. In various implementations, the input/output device 1440 includes a display unit for displaying graphical user interfaces.

According to some implementations of the current subject matter, the input/output device 1440 can provide input/output operations for a network device. For example, the input/output device 1440 can include Ethernet ports or other networking ports to communicate with one or more wired and/or wireless networks (e.g., a local area network (LAN), a wide area network (WAN), the Internet).

In some implementations of the current subject matter, the computing system 1400 can be used to execute various interactive computer software applications that can be used for organization, analysis and/or storage of data in various (e.g., tabular) format (e.g., Microsoft Excel®, and/or any other type of software). Alternatively, the computing system 1400 can be used to execute any type of software applications. These applications can be used to perform various functionalities, e.g., planning functionalities (e.g., generating, managing, editing of spreadsheet documents, word processing documents, and/or any other objects, etc.), computing functionalities, communications functionalities, etc. The applications can include various add-in functionalities or can be standalone computing products and/or functionalities. Upon activation within the applications, the functionalities can be used to generate the user interface provided via the input/output device 1440. The user interface can be generated and presented to a user by the computing system 1400 (e.g., on a computer screen monitor, etc.).

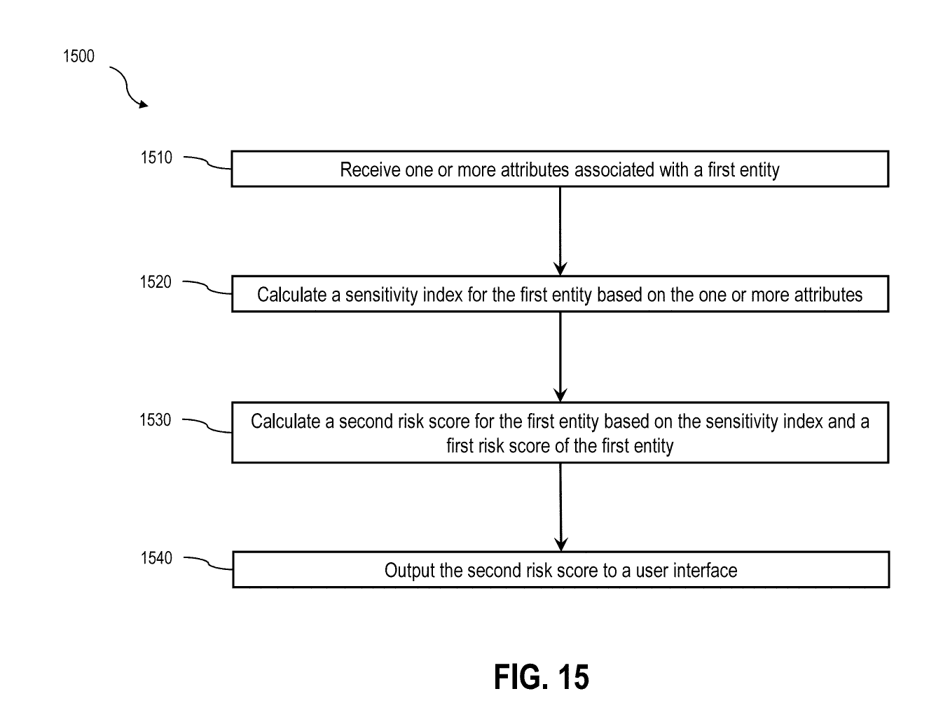

FIG. 15 is a flowchart of a method 1500 for segmenting a population based on sensitivities and a calculating risk score based on the segmented sensitivities. In various implementations, the method 1500 (or at least a portion thereof) may be performed by the computing system 1400, other related apparatuses, and/or some portion thereof. In some aspects, the computing system 1400 may be regarded as a server and/or a computer.

Method 1500 can start at operational block 1510 where the computing system 1400, for example, can receive one or more attributes associated with a first entity. Method 1500 can proceed to operational block 1520 where the computing system 1400, for example, can calculate a sensitivity index for the first entity based on the one or more attributes. In some implementations, calculating a sensitivity index can additionally or alternatively involve the computing system 1400, for example, creating a matched sample of entities, the entities sharing at least one attribute value of the one or more attributes, the matched sample of entities comprising a first sub-population of the entities experiencing a first condition and a second sub-population of the entities experiencing a second condition, the first sub-population different from the second sub-population. In some implementations, calculating a sensitivity index can additionally or alternatively involve the computing system 1400, for example, calculating, for each entity of the matched sample of entities, a sensitivity value associated with the entity, the calculating comprising subtracting an expected performance under the first condition with an expected performance under the second condition. In some implementations, calculating a sensitivity index can additionally or alternatively involve the computing system 1400, for example, segmenting, by the computer processor, any sample of entities into two or more segments based on the sensitivity value of each entity, the sensitivity index comprising one of the two or more segments.

Method 1500 can proceed to operational block 1530 where the computing system 1400, for example, can calculate a second risk score for the first entity based on the sensitivity index and the first risk score of the entity. Method 1500 can proceed to operational block 1530 where the computing system 1400, for example, can output the second risk score to a user interface. While the operational blocks of method 1500 are illustrated and described in a particular order, each of the operation blocks can be performed in any order.

Performance of the method 1500 and/or a portion thereof can allow for improved accuracy of risk scores and additional flexibility to current risk scoring models not previously available. The benefit occurs in at least segmenting heterogeneous entities into “sensitivity segments” based on a sensitivity to a disruption/condition to more accurately predict future payment performance. The entities in any given sensitivity segment can be similarly impacted by a certain type, or definition of, a disruption/condition and that impact can be beneficially added to risk scoring models to output enhanced risk scores.

In some aspects, the risk scores described herein may refer to a credit score or other score to indicate a consumer's creditworthiness.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, one or more aspects or features of the subject matter described herein can be implemented on a computer having a display device, such as for example a cathode ray tube (CRT), a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

What is claimed is:

1. A computer implemented method comprising:
receiving, at a computer processor, one or more attributes associated with a first entity;
calculating, by the computer processor, a sensitivity index for the first entity based on the one or more attributes, wherein calculating the sensitivity index comprises:
creating a matched sample of entities, the entities sharing at least one attribute value of the one or more attributes, the matched sample of entities comprising a first sub-population of the entities experiencing a first condition and a second sub-population of the entities experiencing a second condition, the first sub-population different from the second sub-population;
calculating, for each entity of the matched sample of entities, a sensitivity value associated with the entity, the calculating comprising subtracting an expected performance under the first condition with an expected performance under the second condition; and
segmenting, by the computer processor, any sample of entities into two or more segments based on the sensitivity value of each entity, the sensitivity index comprising one of the two or more segments;
calculating, by the computer processor, a second risk score for the first entity based on the sensitivity index and a first risk score of the first entity; and
outputting, by the computer processor, the second risk score to a user interface.

2. The method of claim 1, wherein calculating the sensitivity index further comprises determining a number of matched entities of a population that share similar attribute values of the at least one attribute at a start time but subsequently experience two different conditions, the number of entities satisfying a threshold, the matched sample of entities comprising the number of entities.

3. The method of claim 2, wherein the determining a number of matched entities of a population that share similar attribute values is based on a propensity score.

4. The method of claim 1, wherein calculating the sensitivity index further comprises:
regressing the matched entities' credit performance values based on the matched entities' attributes at the scoring date and based on the conditions subsequently experienced by the matched entities;
generating, based on the regressing, a regression model to predict sensitivity values from the matched entities' attributes; and
predicting, based on the regression model, a sensitivity value of any entity of interest.

5. The method of claim 3, wherein calculating the sensitivity index further comprises:
predicting a first outcome for each matched entity under the first condition;
predicting a second outcome for each matched entity under the second condition; and
calculating, based on the predicted first and second outcomes, a sensitivity index for each matched entity.

6. The method of claim 4, wherein calculating the sensitivity index for each matched entity comprises subtracting the predicted first outcome under the first condition from the predicted second outcome under the second condition.

7. The method of claim 1, wherein the first condition comprises a stressed condition and the second condition comprises a normal condition.

8. The method of claim 6, wherein the stressed condition comprises one or more of: a recession, a depression, a change in debt, a change in job position, an injury, an accident, a marriage, a divorce, a new child, a change in interest rates, a change in a stock market, a change in debt, a change in credit balance, a new vehicle or home purchase, a severe weather event, a change in health insurance, an exam result, a change in residence, a change in diet, a change in expenses, enrollment in a coaching, or a change in income.

9. The method of claim 1, wherein the sensitivity index comprises at least two segment values, the at least two segment values comprising a first sensitivity index value and a second sensitivity index value, wherein the first sensitivity index value indicates substantially no change in a probability of payment default, and wherein the second sensitivity index value indicates an increased probability of payment default.

10. The method of claim 8, wherein the sensitivity index for the first entity comprises the second sensitivity index value, wherein the second risk score is lower than the first risk score.

11. The method of claim 1, further comprising calculating a probability of repayment for the first entity based on the first risk score and the second risk score.

12. A non-transitory computer program product storing instructions that, when executed by at least one programmable processor, cause at least one programmable processor to perform operations comprising:
receiving one or more attributes associated with a first entity;
calculating a sensitivity index for the first entity based on the one or more attributes, wherein calculating the sensitivity index comprises:
creating a matched sample of entities, the entities sharing at least one attribute value of the one or more attributes, the matched sample of entities comprising a first sub-population of the entities experiencing a first condition and a second sub-population of the entities experiencing a second condition, the first sub-population different from the second sub-population;
calculating, for each entity of the matched sample of entities, a sensitivity value associated with the entity, the calculating comprising subtracting an expected performance under the first condition with an expected performance under the second condition; and
segmenting, by the computer processor, any sample of entities into two or more segments based on the sensitivity value of each entity, the sensitivity index comprising one of the two or more segments;
calculating a second risk score for the first entity based on the sensitivity index and the first risk score of the entity; and
outputting the second risk score to a user interface.

13. The non-transitory computer program product of claim 12, wherein calculating the sensitivity index further comprises determining a number of matched entities of a population that share similar attribute values of the at least one attribute at a start time but subsequently experience two different conditions, the number of entities satisfying a threshold, the matched sample of entities comprising the number of entities.

14. The non-transitory computer program product of claim 13, wherein the determining a number of matched entities of a population that share similar attribute values is based on a propensity score.

15. The non-transitory computer program product of claim 12, wherein calculating the sensitivity index further comprises:
regressing the matched entities' credit performance values based on the matched entities' attributes at the scoring date and based on the conditions subsequently experienced by the matched entities;
generating, based on the regressing, a regression model to predict sensitivity values from the matched entities' attributes; and
predicting, based on the regression model, a sensitivity value of any entity of interest.

16. The non-transitory computer program product of claim 15, wherein calculating the sensitivity index further comprises:
predicting a first outcome for each matched entity under the first condition;
predicting a second outcome for each matched entity under the second condition; and
calculating, based on the predicted first and second outcomes, a sensitivity index for each matched entity.

17. The non-transitory computer program product of claim 16, wherein calculating the sensitivity index for each matched entity comprises subtracting the predicted first outcome under the first condition from the predicted second outcome under the second condition.

18. The non-transitory computer program product of claim 12, wherein the first condition comprises a stressed condition and the second condition comprises a normal condition.

19. A system comprising:
at least one programmable processor; and
a machine-readable medium storing instructions that, when executed by the at least one processor, cause the at least one programmable processor to perform operations comprising:
receiving one or more attributes associated with a first entity;
calculating a sensitivity index for the first entity based on the one or more attributes, wherein calculating the sensitivity index comprises:
creating a matched sample of entities, the entities sharing at least one attribute value of the one or more attributes, the matched sample of entities comprising a first sub-population of the entities experiencing a first condition and a second sub-population of the entities experiencing a second condition, the first sub-population different from the second sub-population;
calculating, for each entity of the matched sample of entities, a sensitivity value associated with the entity, the calculating comprising subtracting an expected performance under the first condition with an expected performance under the second condition; and
segmenting, by the computer processor, any sample of entities into two or more segments based on the sensitivity value of each entity, the sensitivity index comprising one of the two or more segments;
calculating a second risk score for the first entity based on the sensitivity index and the first risk score of the entity; and
outputting the second risk score to a user interface.

20. The system of claim 19, wherein calculating the sensitivity index further comprises determining a number of matched entities of a population that share similar attribute values of the at least one attribute at a start time but subsequently experience two different conditions, the number of entities satisfying a threshold, the matched sample of entities comprising the number of entities.

21. The system of claim 20, wherein the determining a number of matched entities of a population that share similar attribute values is based on a propensity score.

22. The system of claim 19, wherein calculating the sensitivity index further comprises:
regressing the matched entities' credit performance values based on the matched entities' attributes at the scoring date and based on the conditions subsequently experienced by the matched entities;
generating, based on the regressing, a regression model to predict sensitivity values from the matched entities' attributes; and
predicting, based on the regression model, a sensitivity value of any entity of interest.

23. The system of claim 22, wherein calculating the sensitivity index further comprises:
predicting a first outcome for each matched entity under the first condition;
predicting a second outcome for each matched entity under the second condition; and
calculating, based on the predicted first and second outcomes, a sensitivity index for each matched entity.

24. The system of claim 23, wherein calculating the sensitivity index for each matched entity comprises subtracting the predicted first outcome under the first condition from the predicted second outcome under the second condition.

25. The system of claim 19, wherein the first condition comprises a stressed condition and the second condition comprises a normal condition.

26. The system of claim 19, further comprising calculating a probability of repayment for the first entity based on the first risk score and the second risk score.
